(19) United States
(12) Patent Application Publication
(10) Pub. No.: US 2011/0028572 A1
(43) Pub. Date: Feb. 3, 2011

(54) PRODUCT FOR TREATING A TOILET FLUSH CISTERN AND BOWL

(76) Inventors: Gilles ALLARD, Lyon (FR); Michaël SOLL, Saint Genis-Laval (FR)

Correspondence Address: YOUNG & THOMPSON, 209 Madison Street, Suite 500, Alexandria, VA, 22314, US

(21) Appl. No.: 12/897,978

(22) Filed: Oct. 5, 2010

Related U.S. Application Data
(62) Division of application No. 12/279,988, filed on Aug. 20, 2008.

(30) Foreign Application Priority Data
Feb. 20, 2006 (FR) 06/01448

(51) Int. Cl. A01N 25/00; C02F 5/10; A01P 1/00

(52) U.S. Cl. 514/784; 252/180

(57) ABSTRACT

The present invention relates to a liquid additive product including at least one acid, intended, in combination with the water contained in a toilet flush cistern of a WC, to constitute an agent for treating polluting elements contained in the cistern, characterized in that the viscosity of the additive product is less than 500 mPa·s; wherein this acid is an organic acid, the concentration of which is at least equal to 30% by weight. It also relates to a treating agent consisting of the additive product and the water contained in the cistern; wherein the concentration of this additive product, in the water of the cistern, is between 100 ppm and 1000 ppm.

### CROSS REFERENCE TO RELATED APPLICATIONS

This application is a new Divisional of co-pending application Ser. No. 12/279,988 filed on Aug. 20, 2008, which is the 35 U.S.C. §371 national stage of International PCT/FR07/50826 filed on Feb. 20, 2007, which claims priority to French Application No. 0601448 filed on Feb. 20, 2006. The entire contents of each of the above-identified applications are hereby incorporated by reference.

### BACKGROUND OF THE INVENTION

1. Field of the Invention

The present invention relates to an additive product which, in association with water contained in a toilet flush cistern, is suitable for ensuring treatment of the walls of the latter as well as the walls of the bowl it is associated with. The present invention also relates to a treatment agent constituted by this additive with the water from a toilet flush cistern.

2. Description of the Related Art

A toilet flush cistern is known to be fed sometimes by raw water coming from a tap of the water distribution network, and sometimes by recycled water, that is, previously used water such as for example shower water, rain water, etc. This results in a certain number of annoyances for the user.

When the water of a toilet flush cistern has not undergone treatment of any sort and especially not softening treatment, the first reaction is the formation of tartar deposit, whereof the importance is a function of the hydrotimetric degree of the water, in the majority of cases added to by other deposits of a brown colour, depending on the ferric ion content of this water, as well as other mineral deposits.

After a certain time of use, which is a function of the nature of the water used, and especially of its “hardness”, there is formation both in the tank and in the flushing bowl of polluting elements formed from insoluble complexes which, due to evaporation of the water, eventually form deposits also insoluble which, inside the tank, tend to perturb the proper functioning of the mechanisms controlling flushing, which, if not rectified, results in pure and simple blockage of the latter and, inside the bowl, look unsightly and are malodorous.

Apart from the undesirable deposits, the tank and the bowl of a toilet are also the centre of development of other polluting elements made up of microorganisms which are the source of numerous annoyances and especially for the origin of unpleasant odours.

This is why different means for eliminating these polluting elements both from the bowl and the flushing cistern have been proposed. Cleaning products have also been proposed which are in solid form and which, each time the flush is actuated, lose a certain part of their mass by dissolving in the rinsing water of the latter. It is evident that such products had low efficacy, the latter also decreasing as the solid product dissolved.

It has been proposed also to employ liquid cleaning products delivered by equipment located inside either the flushing tank or inside the bowl itself and which, with each actuation, release inside the latter a certain quantity of a cleaning liquid. This cleaning liquid is propelled by the water released during the flushing action, and on the one hand acts on the walls and on the mechanism of the tank and on the other hand on the surface of the bowl. In such systems the water behaves as a transport vector of the cleaning liquid. It is evident that these systems had low efficacy.

Patent application EP-A-0 875 551 in particular discloses cleaning products for acting directly on the surfaces to be treated and, so as to boost the action time of these products on these surfaces, they are given substantial viscosity. Such products are therefore designed to act directly and in the pure state on the surfaces to be treated, so much so that they lose all their efficacy when in the diluted state, such that they are totally inappropriate for treatment of walls of a tank and a bowl of a toilet, by distribution in the water contained therein.

It is also evident that a common disadvantage of equipment delivering liquid products is its incapacity to deliver precise identical doses of cleaning product with each flushing action.

This is why a device has been proposed, in patent application FR 05.10173 registered in the name of the applicants, for delivering small precise liquid doses of cleaning product, in which the filling time of the toilet flushing tank has only a very minor influence on the volume of the dose of liquid product delivered.

### SUMMARY OF THE INVENTION

The aim of the present invention is to propose an additive product to be distributed especially by this type of apparatus, and which, in association with the water contained in a toilet flush cistern, is suitable for ensuring treatment both of the walls of this tank and of the walls of the bowl associated with the latter, so as on the one hand to prevent formation of the various abovementioned deposits and on the other hand to benefit maintenance of the distribution equipment mechanisms. Such a product also benefits maintaining the air in the room accommodating the toilet.

The subject of the present invention therefore is an liquid additive product comprising at least one acid, intended, in association with the water contained in a toilet flush cistern, to constitute a treatment agent of the polluting elements contained in the tank, characterised in that:
its viscosity is less than 500 mPa·s,
this acid is an organic acid, especially a natural organic acid, the concentration of which by weight is at least equal to 30%.

According to the invention the additive product will preferably comprise at least two organic acids, preferably natural, at least one of these acids able to be citric acid, acetic acid or oxalic acid. At least one of the organic acids could also be a synthetic acid, especially belonging to the group constituted by polyacrylic acid, or polymaleinic acid or phosphonic acid.

Also, the additive product according to the invention will advantageously contain at least one element suitable at least for slowing photosynthesis. Such an element could for example be constituted by a dye which thus covers three functions in the additive product according to the invention, specifically a first function of decorative order, classic in this type of product, a second function, specifically an antiphotosynthesis function, and a third function, specifically an indicator showing proper dosage or the end of the product in the dosing device.

The additive product could also comprise at least one perfume oil whereof the concentration by total weight of the product will be at least equal to 2%; the latter could be especially associated with at least one short molecular chain volatile alcohol, especially constituted by methanol, and/or ethanol and/or propanol, whereof the concentration will preferably be equal to 2% by total weight of the product.

The additive product could also contain at least two surfactants, one of which could be of non-ionic type. Finally, the additive product could contain a biocide in the form of cationic surfactant, especially QAV, specifically a quaternary ammonium.

Another subject of the present invention is a treatment agent of the pollutants contained in a toilet flush cistern, characterised in that it is constituted:
by the water contained in said tank,
by an additive product, such as that previously mentioned, specifically a liquid additive product comprising at least one organic acid whereof the concentration by weight is at least equal to 30%, and whereof the viscosity is less than 500 mPa·s,
the concentration in the water of the tank of this additive product being between 100 ppm and 1000 ppm and preferably equal to around 400 ppm.

### BRIEF DESCRIPTION OF THE DRAWING FIGURE

FIG. 1 shows a curve representative of the detartaring action of a treatment agent according to the invention.

### DETAILED DESCRIPTION OF THE INVENTION

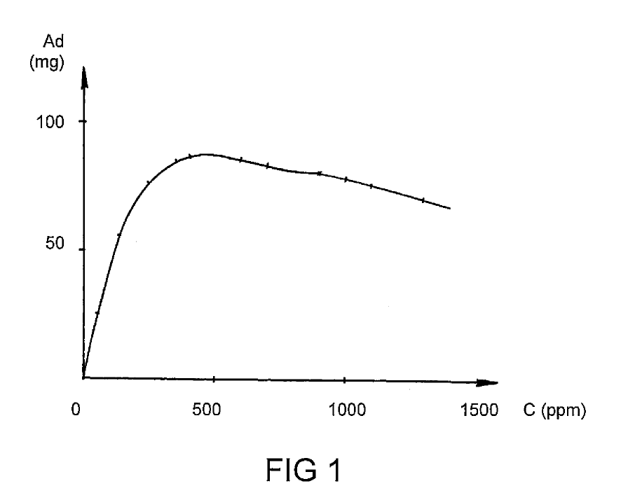

An embodiment of the present invention will now be described hereinbelow, by way of non-limiting example, in reference to the attached diagram in which FIG. 1 only is a curve representative of the detartaring action of a treatment agent according to the invention, as a function of the concentration of additive product in the water of the toilet cistern.

Contrary to those liquid products normally used for cleaning and maintaining toilet bowls, the function of the additive product according to the invention is also to ensure maintenance of water flushing tanks, or tanks which house mechanisms which must be devoid of all deposits likely to impede or modify their operation to stay operational.

More specifically, the additive product according to the invention, even though it may be used with any distribution system, is however particularly intended to be distributed by mechanical and automatic equipment which, placed in the cistern, have the particular feature of delivering strictly calibrated small doses (of the order of 2 cm³) of additive product, irrespective of the level of the water in the flushing tank.

According to the invention, when added to the water of a toilet cistern this additive product forms an association with the water contained therein a treatment agent capable of destroying and preventing any pollution from forming, chiefly tartar and microorganisms.

It is evident that the detartaring action of the treatment agent was a function of its concentration of additive product in the water of the flushing tank. FIG. 1 illustrates the variation of the detartaring action Ad of the treatment agent as a function of its concentration C of additive product. The detartaring action represents the loss by weight (in mg) of a given mass of tartar over a week. It is noted that the detartaring action grows proportionally to the concentration, reaching a maximum of around 400 ppm, then tapering off. There is therefore an optimal dosage of additive product at around 400 ppm.

The specific character of the additive product, that is, a liquid product to be distributed by apparatus in the form of low-volume doses, also implies that surface tension phenomena do not oppose the free flow of the product, so much so that this excludes using the majority of products normally used in this domain, of the type especially which are employed in the pure state directly on the surfaces to be treated of a toilet bowl. It is noted that the viscosity of the additive product should be at most equal to 500 mPa·s.

In addition, due to the abovementioned specificity, the treatment agent is brought into contact with mechanisms comprising tight joints made of rubber or elastomer and it is necessary that it does not degrade these elements, and mainly these joints, but on the contrary contributes to proper maintenance thereof.

Using an additive product constituted by a high-concentration organic acid resulted in highly efficacious activity on the tartar, without the constraint of using thickeners for prolonging the contact time, and therefore activity time, of the product with the surfaces to be cleaned and/or maintained.

It is also known that the cleaning products and/or maintenance for flushing lead to difficulty which is the increase in concentration of the product over time (essentially due to evaporation of the liquid phase contained in the product) which translates by an increase in its viscosity. Such an increase in viscosity is particularly annoying, or even unacceptable, when said product must be distributed by a device in which the ease of flow is a condition of proper functioning. It is evident that using a highly concentrated organic acid, that is, at a concentration by total weight of the product greater than 30%, fixed the water in the additive product and that accordingly the phenomenon of evaporation became negligible, thus allowing use of the latter in equipment of the abovementioned type.

According to the invention it is also evident that by using a blue dye the latter was effectively filtering light rays, resulting in a drop in the importance of the photosynthesis phenomenon, thus preventing development of green algae which form on toilet bowls. Also, the colour, which is readily perceptible by the user, will allow the latter to determine whether the quantity of additive product distributed in the tank and the toilet flushing bowl is of adequate in quantity.

The additive product according to the invention could also comprise perfume oil at a relatively high concentration rate for this type of product. Apart from its natural function, the highly concentrated perfume oil, that is above approximately 2%, then also ensures a biocide function, this biocide function combating the formation of microorganism sources especially of unpleasant odours.

It is also evident that adding to this perfume at least one short molecular chain volatile alcohol, especially of methanol, ethanol or propanol type at a concentration at least equal to 2% by weight of the total weight of additive product, on the one hand emphasised the volatile effect of this perfume and, on the other hand ensured stabilising of the additive product at temperatures under 10° C.

The assays conducted over several months in real conditions of use established that an additive product according to the invention thus ensured that the embodiment explained hereinbelow simultaneously produced:
total elimination of tartar and rust deposits on the one hand on the walls of the flushing tank and on the other hand on the mechanism elements and on the walls of the bowl of the latter,
brilliance at the surface level of the latter,
suppression of proliferation of microorganisms, as well as green and black algae,
protection of the joints of the flushing mechanism and of the distribution apparatus of the additive product,
optimal functioning in the equipment requiring products to be distributed having low viscosity,
optionally permanent distribution of perfume in the air of the room,
optionally decorative colouring of the water in the toilet bowl.

### Example 1

| | |
|---|---|
| Citric acid | 50% |
| Non-ionic surfactant | 5% |
| Cationic surfactant | 1% |
| (didecyldimethyl ammonium chloride) | |
| Blue dye (E133) | 0.1% |
| Perfume (lavender) | 5% |
| Isopropanol | 6% |
| Distilled water | to complete |

### Example 2

| | |
|---|---|
| Citric acid | 50% |
| Non-ionic surfactant | 4% |
| Anionic surfactant | 4% |
| Blue dye | 0.06% |
| Perfume | 7% |
| Isopropanol | 3% |
| Glycerin | 5% |
| Organic acid (polyacrylic acid) | 5% |
| Distilled water | to complete |

What is claimed is:

1. A method for treating pollutants contained in a toilet flush cistern and bowl, comprising:
adding a liquid additive product to the cistern at a level between 100 ppm and 1000 ppm, wherein
the liquid additive product comprises formula 1 or formula 2,
formula 1 comprises at least 30 wt % of at least one organic acid, 5 wt % non-ionic surfactant, 1 wt % of cationic surfactant, 0.1 wt % blue dye, at least 2 wt % perfume, 6 wt % C1-C3 alcohol and balance distilled water, and
formula 2 comprises at least 30 wt % of at least one organic acid, 4 wt % non-ionic surfactant, 4 wt % of anionic surfactant, 0.06 wt % blue dye, at least 2 wt % perfume, 3 wt % C1-C3 alcohol, 5 wt % glycerin, 5 wt % synthetic acid, and balance distilled water.

2. The method for treating pollutants according to claim 1, wherein the at least one organic acid is citric acid.

3. The method for treating pollutants according to claim 1, wherein there is 50 wt % of the at least one organic acid.

4. The method for treating pollutants according to claim 1, wherein the synthetic acid is selected from the group consisting of polyacrylic acid, ploymaleinic acid and phosphonic acid.

5. The method for treating pollutants according to claim 1, wherein the C1-C3 alcohol is isopropanol.

6. The method for treating pollutants according to claim 1, wherein the cationic surfactant is a quaternary ammonium surfactant.

7. The method for treating pollutants according to claim 1, wherein the cationic surfactant is didecyldimethyl ammonium chloride.

8. The method for treating pollutants according to claim 1, wherein the blue dye impedes photosynthesis.

9. The method for treating pollutants according to claim 1, wherein the blue dye is E133.

10. The method for treating pollutants according to claim 1, wherein the perfume is lavender.

11. The method for treating pollutants according to claim 1, wherein in the formula 1 there is 5 wt % perfume.

12. The method for treating pollutants according to claim 1, wherein in the formula 1 there is 7 wt % perfume.

13. The method for treating pollutants according to claim 1, wherein the liquid additive has a viscosity of less than 500 mPa·S.

14. The method for treating pollutants according to claim 1, wherein the cationic surfactant is a biocide.

15. The method for treating pollutants according to claim 1, wherein the at least 2 wt % perfume ensures a biocide function.

16. The method for treating pollutants according to claim 1, wherein the liquid additive product is present at about 400 ppm, whereby detartaring activity reaches a maximum.

17. The method for treating pollutants according to claim 1, wherein a magnitude of each does is of an order of 2 cm³.

18. A kit-of-parts comprising an apparatus for delivering strictly calibrated doses of the liquid additive product according to the method of claim 1 to a toilet flush cistern.
